(19) United States
(12) Patent Application Publication
(10) Pub. No.: US 2016/0272813 A1
(43) Pub. Date: Sep. 22, 2016

(54) Thermoplastic elastomer compositions resistant to silicone oil

(71) Applicant: Kraiburg TPE GmbH & Co. KG, Waldkraiburg (DE)

(72) Inventors: Valérie WIEDERHIRN, St. Wolfgang (DE); Florian VETTER, Kraiburg a. Inn (DE)

(21) Appl. No.: 14/778,449

(22) PCT Filed: Oct. 23, 2014
(86) PCT No.: PCT/EP2014/072723

§ 371 Date: Sep. 18, 2015

(30) Foreign Application Priority Data
Oct. 23, 2013 (DE) 10 2013 017 518.6
Dec. 3, 2013 (DE) 10 2013 018 101.1

(51) Int. Cl. C08L 75/04; C08L 53/02; C08L 53/00

(52) U.S. Cl. CPC C08L 75/04; C08L 53/00; C08L 53/02; C08L 2205/02; C08L 2205/06; C08L 2201/08; C08L 2207/04

(57) ABSTRACT

The present invention relates to thermoplastic elastomer compositions resistant to silicone oil. The thermoplastic elastomer compositions, hereinafter also called TPE compounds, moreover have Shore A hardness from 40 to 90 ShA and after storage in silicone oil exhibit very little change of mechanical properties such as hardness, elongation at break, and tensile strength, or of swelling behaviour. The thermoplastic elastomer compositions according to the invention moreover exhibit very good adhesion on thermoplastics such as polypropylenes (PP), polyethylenes (PE), polyamides (PA), polyethylene terephthalate (PET), polybutylene terephthalate (PBT), acrylonitrile-butadiene-styrene polymers (ABS), polycarbonates (PC), acrylate-styrene-acrylonitrile polymers (ASA), styrene-acrylonitrile polymers (SAN), polyoxymethylenes (POM) and blends of these, for example PC-ABS blends (PC/ABS).

The present invention relates to thermoplastic elastomer compositions resistant to silicone oils. The thermoplastic elastomer compositions, hereinafter also called TPE compounds, moreover have a Shore A hardness of from 40 to 90 ShA and after storage in silicone oils exhibit very little change of mechanical properties such as hardness, elongation at break, tensile strength, and swelling behaviour. The thermoplastic elastomer compositions according to the invention moreover exhibit very good adhesion on thermoplastics such as polypropylenes (PP), polyethylenes (PE), polyamides (PA), polyethylene terephthalates (PET), polybutylene terephthalates (PBT), acrylonitrile-butadiene-styrene polymers (ABS), polycarbonates (PC), acrylate-styrene-acrylonitrile polymers (ASA), styrene-acrylonitrile polymers (SAN), polyoxymethylenes (POM) or blends of these, for example PC-ABS blends (PC/ABS).

The thermoplastic elastomers (TPE) described herein follow the definitions as described in “G. Holden, H. R. Kricheldorf, R. P. Quirk (Eds.), Thermoplastic Elastomers, Carl Hanser Verlag, 3rd Ed., Munich (2004)” or “http://en.wikipedia.org/wiki/Thermoplastic_elastomer”.

Process oils, also called plasticizers, are usually added to TPE and/or TPE compounds in order to achieve certain degrees of hardness and ensure a good processability during the production and further processing. Typical process oils can comprise paraffin oils, in particular technical or medical white oils, virgin oils, such as for example soybean or rapeseed oil, alkylsulfonyl esters, in particular alkylsulfonyl phenyl esters, wherein the alkyl substituents contain linear and/or branched alkyl chains with >5 C atoms. In addition, di- or trialkyl esters of mellitic acid, wherein the alkyl substituents contain linear and/or branched alkyl chains with >4 C atoms. Furthermore, alkyl esters of di-, tri- and higher polycarboxylic acids, wherein the alkyl substituents are linear and/or branched alkyl chains, are also used as process oils. Examples are adipic acid di-2-ethylhexyl ester and tributyl O-acetylcitrate. Furthermore, carboxylic acid esters of mono- and/or polyalkylene glycols can also be used as process oils, such as for example ethylene glycol adipate. Mixtures of the described substance classes can also be used as process oils.

However, the TPEs or TPE compounds which contain the described process oils have the disadvantage that their mechanical properties deteriorate when they come into contact with oils or oily media, and thus the components or shaped bodies produced therefrom can no longer be used. This deterioration of the mechanical properties occurs in particular after contact with silicone oils. Either the process oils are leached or the silicone oil can be absorbed. Sometimes both processes can take place, in which case, however, one predominates. Through leaching, the volume decreases; the component displays shrinkage. Through absorption, the volume increases; the component displays swelling behaviour.

Within the meaning of the invention, silicone oils are chemical compounds of the general structural formula HₙR₍₃₋ₙ₎Si—[O—SiR₂]_{y}—O—SiR₍₃₋ₘ₎Hₘ, wherein R can be alkyl groups, preferably methyl groups, n, m=1 to 3 and y=1 to 1000. In general, compounds of the specified structural formula are also called linear siloxanes, more specifically diorganopolysiloxanes. Furthermore, the term silicone oils is understood to include cyclic silicone oils of the general structural formula —[O—SiR₂]_{z}—. In this case, R are alkyl groups, preferably methyl and z=3 to 8, preferably 4 to 6.

Silicone oils are used both in technical applications, for example as compressor oils or pump oils, as well as in medical and cosmetic applications, where they are used for example as foam-inhibiting substances or lubricants. It can be seen that materials such as seals, housings or other components which come into direct contact with silicone oils must therefore remain resistant with respect to their physical properties in order to meet the technical requirements.

The object of the invention was therefore to provide TPE compounds which have a certain degree of hardness and a corresponding elasticity, are resistant to silicone oils and at the same time have a good adhesion on thermoplastics. Furthermore, the compounds should in particular be able to be processed in an injection moulding process, in particular in the use of at least a 2-component process.

The object was achieved by a TPE compound, comprising a thermoplastic elastomer (basic TPE) and a polymeric additive which is phase-compatible with TPE, wherein the additive has a hardness that is 5 to 50 ShA lower than that of the basic TPE and wherein the polymer composition has a Shore A hardness of from 40 to 90 ShA.

The TPE compounds contain <5 wt.-% standard process oils or plasticizers, preferably <2 wt.-%. According to a further embodiment, the TPE compound does not contain any plasticizers or process oils, and is thus free of plasticizer. The polymer compositions have a Shore A hardness of from 40 to 90 ShA. Furthermore, the compounds can contain further TPEs, thermoplastic polymers and optionally further additives.

It was surprisingly found that the use of TPE compounds containing at least a mixture of a basic TPE and a soft, polymeric, phase-compatible additive can achieve the desired Shore hardness with plasticizer additions of <5 wt.-% and are additionally resistant to the disadvantageous action of silicone oils or silicone oil-containing substances. In both cases, the polymeric additive takes on the effect of the standard plasticizers and process oils.

In addition, it was surprisingly shown that the compounds according to the invention have a very good adhesion on common thermoplastics (e.g. PP, PA, PC, ABS, ASA, SAN, PET, PBT, POM). The good adhesion is maintained after storage in silicone oil.

In a standard measurement in accordance with the provisions of DIN ISO 1817, after 30 days of action of silicone oils at 55° C. little change in the mechanical properties such as the hardness, elongation at break, tensile strength could be established. Likewise, the component which was produced from the compound according to the invention shows little shrinkage or swelling behaviour. A person skilled in the art says “resistant” in connection with volume change of the component or shaped body in the case of changes of <5 vol.-%.

By TPEs according to the invention is meant both block copolymers which display TPE behaviour due to their internal molecular structure as well as polymer mixtures of thermoplastics and elastomers which have TPE behaviour. In both cases, hard, thermoplastic and soft, elastomeric domains form. On the action of heat, the thermoplastic areas fuse; the TPE can then be processed like a thermoplastic. Upon cooling, these hard areas solidify again; the material then displays elastic properties of the soft domains. Styrene block copolymers (TPE-S), thermoplastic polyester elastomers (TPE-E), thermoplastic polyurethane elastomers (TPE-U), thermoplastic polyamide elastomers (TPE-A) and thermoplastic olefin elastomers (TPO) from block copolymers are specified as TPE block copolymers according to the invention. TPEs according to the invention which are composed of polymer mixtures are polyolefin mixtures of non-cross-linked and/or slightly cross-linked polyolefins (TPE-O) and cross-linked or also vulcanized polyolefins (TPE-V). In a general sense, however, TPE-Vs are also understood to include polymer mixtures of thermoplastic polymers and cross-linked elastomers in general.

TPE-Ss are triblock copolymers A-B-A, wherein the A block is usually polystyrene and the B block is usually built up of polybutadiene, polyisoprene or polyisobutene (SBS, SIS, SiBS). Alternatively, in the A block the styrene monomers can be partially or completely replaced by derivatives of styrene, such as for example α-methylstyrene and tert-butylstyrene. The B block can also alternatively contain mixtures of dienes, such as SIBS (B block of a mixture of butadiene and isoprene). Furthermore, TPE-Ss consisting of styrene and diene monomers can also be used as hydrogenated derivatives. Polystyrene-block-poly(ethylene-co-butylene)-block-polystyrene (SEBS) and polystyrene-block-poly(ethylene-co-(ethylene-propylene))-block-polystyrene (SEEPS) are specified here as preferred.

TPE-Es of the present invention are linear multiblock polyesters with statistical distribution of high-melting-point, hard polyester blocks and low-melting-point, soft polyester blocks. The hard blocks form crystalline areas, and the soft blocks form amorphous areas which determine the elastic behaviour at the usage temperatures of the TPE-Es. The hard polyester blocks are built up of short-chain dicarboxylic acids with fewer than 4 C atoms or aromatic dicarboxylic acids or mixtures of dicarboxylic acids. Aromatic dicarboxylic acids are preferred, isophthalic acid or terephthalic acid are particularly preferred. The alcohol component is preferably likewise difunctional and consists of short-chain alkyl diols or short-chain polyoxyalkylene diols with fewer than 3 repeat units or mixtures of different diols. Short-chain diols such as ethylene glycol, 1,3-propanediol, 1,4-butanediol, 1,4-cyclohexanedimethanol are preferred; 1,4-butanediol is particularly preferred. The soft polyester blocks consist of aliphatic or aromatic dicarboxylic acids, preferably of aromatic dicarboxylic acids, quite particularly preferably of isophthalic acid or terephthalic acid. In order to produce soft areas in the case of the TPE-Es, different diol types are used, polyether diols such as polyethylene glycols, polypropylene glycols, polyethylene-co-propylene glycols, polytetramethylene glycols or soft polyester diols built up of alkanedicarboxylic acids, for example adipic acid or sebacic acid, and alkane diols, or polycaprolactone diols or aliphatic polycarbonate diols. However, mixtures of diols can also be used. Hard TPE-E areas built up of terephthalic acid and short-chain diols, particularly preferably 1,4-butanediol, are preferred, combined with soft areas, preferably built up of terephthalic acid and polyether diols, quite particularly preferably of polytetramethylene glycol.

TPE-Us according to the invention consist of linear, statistically constructed polyurethanes with alternating hard, crystalline and soft, amorphous segments. The hard segments are built up of polymers of diisocyanates and short-chain chain extenders which are linked to each other via urethane groups. For example, 4,4′-diphenylmethane diisocyanate (MDI), hexamethylene diisocyanate (HDI), H12-MDI are used as diisocyanate, wherein MDI is preferred. Short-chain diols, such as ethylene glycol, diethylene glycol, 1,4-butanediol, 1,6-hexanediol, can be used as chain extenders. Diethylene glycol and 1,4-butanediol are preferred as chain extenders, 1,4-butanediol is particularly preferred. The soft segments typically consist of long-chain polyether diols or polyester diols. Polyether diols can be polyethylene glycols, polypropylene glycols, polyethylene-co-propylene glycols, polytetramethylene glycols, preferably polytetramethylene glycol. Polyester diols are built up of alkanedicarboxylic acids, preferably adipic acid and alkane diols, for example ethylene glycol, 1,4-butanediol, 1,6-hexanediol. Furthermore, polycaprolactone diols or aliphatic polycarbonate diols are also used as soft segments. The soft segments are linked via urethane groups to the hard segments.

TPE-As of the present invention are characterized in that they have polyamides as hard, crystalline segments. The soft, amorphous areas consist of polyethers and/or polyesters. Polyester amides, polyether ester amides, polycarbonate ester amides and polyether block amides are distinguished. Polyester amides, polyether ester amides and polycarbonate ester amides are formed by reacting aromatic diisocyanates with aliphatic dicarboxylic acids, which form the polyamide blocks, and carboxyl-terminated aliphatic polyesters (resulting in polyester amides), carboxyl-terminated aliphatic polyester ethers (resulting in polyether ester amides) and carboxyl-terminated polycarbonate diols (resulting in polycarbonate ester amides). Polyether block amides are formed by reacting carboxyl-terminated polyamides and hydroxy-terminated polyether diols. Polyether block amides are preferred as TPE-As; those with polytetramethylene glycol as soft segment are particularly preferred.

Of the polymers described in chapter 5 of “G. Holden, H. R. Kricheldorf, R. P. Quirk (Eds.), Thermoplastic Elastomers, Carl Hanser Verlag, 3rd Ed., Munich (2004)”, the block copolymers are to be preferred as TPE-Os according to the invention (section 5.3). It is particularly preferred for the use described here that TPE-Os are built up of block copolymers of PP and PE.

TPE-Vs according to the invention are described in chapter 7 of “G. Holden, H. R. Kricheldorf, R. P. Quirk (Eds.), Thermoplastic Elastomers, Carl Hanser Verlag, 3rd Ed., Munich (2004)”. Polymer blends of EPDM/PP, NR/PP (NR, natural rubber), NBR/PP, XIIR/PP (XIIR, cross-linked butyl rubber) and EVA/PVDC (EVA, ethylene-vinyl acetate) are preferred. EPDM/PP is particularly preferred.

From the series of TPEs described, TPE-S, TPE-E, TPE-U and TPE-V are preferred as basic TPE for the production of the TPE compounds according to the invention. TPE-S, TPE-E and TPE-V are particularly preferred.

In addition to at least one basic TPE, TPE compounds which are silicone oil-resistant contain one or more soft, polymeric, phase-compatible additives. By soft, polymeric, phase-compatible additives is meant those which have a molecular weight of at least 500 g/mol and consist of at least three repeat units. Furthermore, the additives have a hardness that is 5 to 50 ShA lower than that of the basic TPE. The TPE compounds according to the invention, which consist of at least a basic TPE and the additive, must have a Shore A hardness of from 40 to 90 ShA, preferably 40 to 80 ShA, quite particularly preferably of from 60 to 80 ShA. At the same time, the TPE compounds, made of mixtures of at least one TPE compound and at least one additive, must not display any macroscopic phase separation or delamination after the compounding, and are thus to be phase-compatible or phase-stable. A person skilled in the art is familiar with the occurrence of macroscopic phase separation and is able to evaluate this for compatibility, thus a stable compound, or incompatibility and thus unstable and not technically usable compound. The phase separation can be recognized visually.

TPEs which have a hardness that is 5 to 50 ShA lower than that of the basic TPE and are phase-compatible with the basic TPE are specified as soft, polymeric, phase-compatible additives. Furthermore, copolymers which do not display any TPE behaviour themselves but which fulfil the named criteria are also specified, however. For example, acrylate copolymers such as a terpolymer of butyl acrylate-methyl methacrylate-acrylonitrile.

The preselection of an additive with regard to compatibility can be carried out by a person skilled in the art, but should be tested from case to case by an experiment. On this point, it is mentioned for example that there can be phase compatibility between polar basic TPEs, such as TPE-E or TPE-U and polar additives or nonpolar basic TPE-S with TPE-O as additive. However, combinations between for example basic TPE-S and TPE-E as additive can also be possible if the molecular structure and quantity ratios of the components allow compatibility.

To produce the described TPE compounds, with <5 wt.-% process oil, preferably <2 wt.-% and quite particularly preferably without any process oil, optionally further TPEs and/or thermoplastic polymers and/or further additives can be added in addition to the basic TPE and the phase-compatible additive.

TPEs as were described for the basic TPE are specified as further TPEs, preferably TPE-S, TPE-E, TPE-U and TPE-V. PE, PP, PS, PA, PC, ABS, ASA, SAN, PET, PBT, POM, PPO (polyphenylene oxide) are specified for example as additional, optional thermoplastic polymers. These thermoplastics can also be present chemically modified, for example PP grafted with maleic acid anhydride. Preferred optional thermoplastic polymers are PP, PS and chemically modified PP.

Process additives, stabilizers or fillers can be added to the TPE compounds according to the invention as further additives. Process oils can be added as necessary, but <5 wt.-%, preferably <2 wt.-%. According to a further embodiment of the invention, no process oils are added.

Antistatic agents, anti-foam agents, lubricants, dispersants, release agents, antiblocking agents, radical scavengers, antioxidants, biocides, fungicides, UV stabilizers, other light-protection agents, metal deactivators, furthermore also additives such as foaming aids, propellants, flame-proofing agents, smoke suppressants, impact resistance modifying agents, adhesion promoters, anti-fog agents, dyes, pigments, colour masterbatches, viscosity modifiers are specified as process additives and stabilizers. Kaolin, mica, calcium sulfate, calcium carbonate, silicates, silica, talc, carbon black, graphite or synthetic fibres are mentioned as fillers, for example.

The TPE compounds according to the invention comprising or consisting of at least a mixture of a basic TPE and a soft, polymeric, phase-compatible compound, are composed of a weight ratio of basic TPE to additive of from 5:1 to 1:5. The mixture is preferably present in a ratio of from 4:1 to 1:4 and particularly preferably of 3:1 to 1:3 basic TPE/additive. In the quite particular embodiment, the phase-compatible additive is a TPE which is softer by 5 to 50 ShA.

Furthermore, the TPE compounds can contain further TPEs, thermoplastic polymers and/or further additives. Further optional TPEs are added in the range of from 0 to 20 wt.-% relative to the total mixture, wherein preferably below 15 wt.-% is added. Addition quantities of thermoplastics lie in the range of from 0 to 30 wt.-%, preferably 0 to 25 wt.-% and particularly preferably 0 to 20 wt.-%. From the list of possible further additives, fillers are added from 0 to 25 wt.-%, preferably 0 to 20 wt.-% and in particular 0 to 15 wt.-%. UV stabilizers, process stabilizers and antioxidants contained in the TPE compound lie in the range of from 0 to 0.5 wt.-%, preferably 0 to 0.2 wt.-% and particularly preferably 0.05 to 0.1 wt.-%.

The production of the compounds is carried out by means of usual mixing units. Suitable units can be extruders, internal mixers or kneaders. The homogeneous distribution of the individual raw materials of the respective compounds is to be ensured. Preferred units are extruders, in particular twin-screw extruders.

The intended hardnesses of the TPE compounds according to the invention lie in the range of from 40 to 90 ShA, preferably 40 to 80 ShA, quite particularly preferably of from 60 to 80 ShA.

The TPE compounds according to the invention are eminently suitable for example for use in components and shaped bodies which are produced in an injection moulding or multi-component injection-moulding process and which have a high resistance to silicone oils and at the same time adhere well.

The present invention also relates to the use of the TPE compounds according to the invention for the production of various products in the typical fields of application of TPEs. These are components and shaped bodies in the interior and external area of automobiles, industrial devices, industrial tools, bathroom fittings, domestic appliances, medical consumables and devices, sporting goods, containers for hygiene products and cosmetics. In general, sealing materials which are to block against media. These media can be lubricants and mixtures thereof or preparations of consumables which contain silicone oils.

The invention is now to be explained in more detail with reference to some embodiment examples, wherein these serve only for explanation and are not to be considered as limiting the scope of protection of the invention.

### EMBODIMENT EXAMPLES

### 1. Production of the Compounds

All compounds developed and tested according to the invention were produced on a twin-screw extruder with screws running in the same direction and a melt pump. The screw diameter is 27 mm, the L/D ratio is 46. The extruder has eight temperature-controlled extruder zones. The rotational speed of the screw is between 100 and 800 revolutions per minute. Granulation is then carried out under water.

### 2. Results

As described above, Examples A to F were produced and correspondingly measured. The corresponding weight proportions of the components used can be found in the following Table 1.

TABLE 1
composition of the compounds and measurement results

| | Hardness | | Example A | | | | Example E | |
|---|---|---|---|---|---|---|---|---|
| | (ShA) | | reference | Example B | Example C | Example D | reference | Example F |
| Process oil | | wt.-% | 27.2 | 0 | 0 | 0 | 52.8 | 0 |
| TPE-E | 78 | wt.-% | 20.7 | 41.5 | 41.5 | 36.7 | 0 | 0 |
| TPE-U (aliphatic) | 70 | wt.-% | 31.1 | 41.5 | 0 | 0 | 0 | 0 |
| TPE-U (aromatic) | 60 | wt.-% | 0 | 0 | 41.5 | 0 | 0 | 0 |
| TPE-S 1(SEBS) | 76 | wt.-% | 0 | 0 | 0 | 0 | 29.4 | |
| TPE-S 2 | 50 | wt.-% | 0 | 0 | 0 | 0 | 0 | 62.4 |
| TPE-O | 75 | wt.-% | 0 | 0 | 0 | 0 | 0 | 31.2 |
| PP | | wt.-% | 0 | 0 | 0 | 0 | 17.6 | 6.2 |
| Calcium carbonate | | wt.-% | 20.5 | 16.5 | 16.5 | 7.4 | 0 | 0 |
| Stabilizers | | wt.-% | 0.5 | 0.5 | 0.5 | 0.5 | 0.2 | 0.2 |
| Density | g/cm³ | 1.26 | 1.233 | 1.242 | 1.162 | 0.885 | 0.897 | |
| Hardness | ShA | 60 | 75 | 74 | 77 | 63 | 60 | |
| Tensile strength | MPa | 6.7 | 15.5 | 11.4 | 6.8 | 4.3 | 12.6 | |
| Elongation at tear | % | 1070 | 1100 | 1050 | 430 | 500 | 850 | |
| Adhesion on PET | N/mm | 4 | 8 | 2 | 2 | — | — | |
| Adhesion on PC | N/mm | 13 | 46 | 30 | — | — | — | |
| Adhesion on ABS | N/mm | 4 | 41 | 30 | — | — | — | |
| Adhesion on PP | N/mm | — | — | — | — | 14 | 16 | |

Swelling result:

| | | | | | | | |
|---|---|---|---|---|---|---|---|
| Silicone oil resistant | — | no | yes | yes | yes | no | yes |

All TPE compounds produced according to the specification presented above lie within the desired intended hardness ranges.

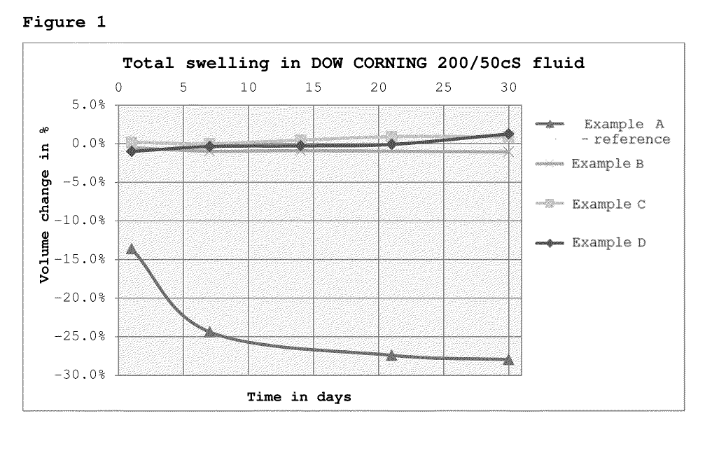

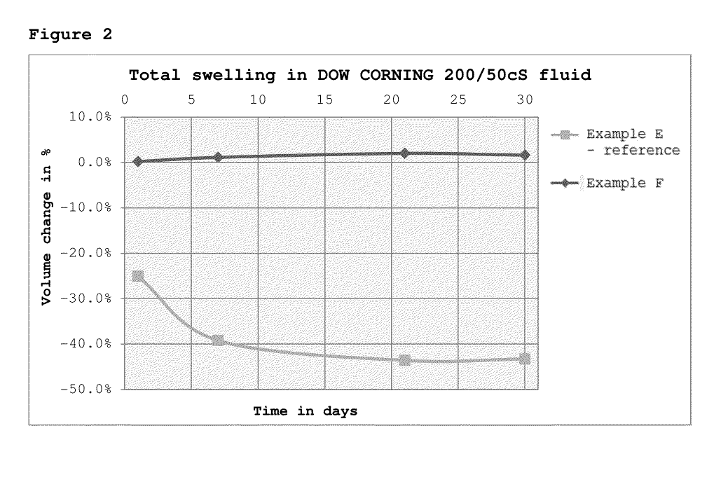

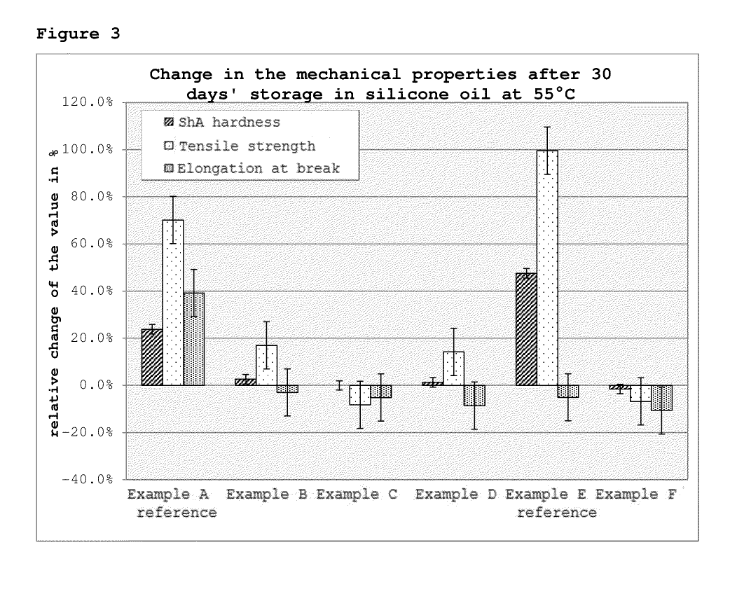

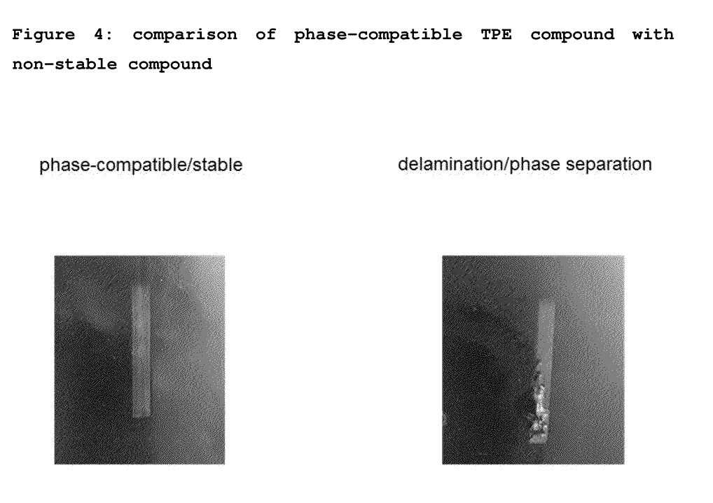

The measurement of the silicone oil resistance took place in accordance with DIN ISO 1817. The volume change and mechanical properties of the test piece were measured for 30 days at 55° C. under the action of a silicone oil (DOW CORNING® 200 FLUID, 50 CST). These conditions are usually used for everyday objects which are used at room temperature. After 14 days, a plateau in the change of the mechanical properties is reached, which barely changes any further in the further course of time. After 30 days, no significant change in the mechanical properties, such as hardness, elongation at break, tensile strength, and no volume or weight change could be established. All data relating to the TPE compounds before, during and after the resistance test in silicone oil can be found in FIGS. 1 to 3 below. FIG. 4 shows a visual comparison of a phase-compatible TPE compound with a non-stable TPE compound.

### 3. Adhesion

The TPE-E/TPE-U compounds adhere to the following thermoplastics: PC, ABS, ASA, PET.

The TPE-S/TPE-O based mixtures adhere to PP.

### 4. Test Standards Relating to the Tests Carried Out

| Method | Standard |
|---|---|
| Determining hardness | DIN 53505 |
| Determining density | DIN EN ISO 1183-1 |
| Determining tensile strength | DIN 53504 |
| and elongation at tear | |
| Determining adhesion | Renault Norm D41 1916/--C |
| Determining further tear | DIN ISO 34-1 |
| resistance | |

### 5. Determining the Swelling Behaviour

For determining the increase in volume, a test piece with a diameter of 30 mm and a thickness of 2+/−0.05 mm was used. For determining the tear strength and elongation at tear, an S2 test piece with a thickness of 2+/−0.05 mm was used.

The test pieces were inserted into polydimethylsiloxane DOW CORNING® 200 FLUID, 50 CST and stored at 55+/−2° C. at 100% wetting of the test pieces (total swelling). The test pieces were removed after 1, 7, 21 and 30 days (limit value reached after approx. 21 days).

1. A thermoplastic elastomer compound, comprising a thermoplastic elastomer and a polymeric additive which is phase-compatible with the thermoplastic elastomer, wherein the additive has a hardness that is 5 to 50 ShA lower than that of the thermoplastic elastomer and wherein the compound has a Shore A hardness of from 40 to 90 ShA.

2. The compound according to claim 1, wherein the thermoplastic elastomer is selected from the group consisting of TPE-A, TPE-S, TPE-E, TPE-U, TPE-O and TPE-V.

3. The compound according to claim 1, wherein the weight ratio thermoplastic elastomer/additive lies in the range of from 5:1 to 1:5.

4. The compound according to claim 1, wherein the composition contains less than 5 wt.-% process oils.

5. The compound according to claim 1, wherein the polymeric additive has a molecular weight of at least 500 g/mol and at least 3 repeat units.

6. The compound according to claim 1, wherein the polymeric additive is a thermoplastic elastomer or a copolymer without thermoplastic elastomer behaviour which has a hardness that is 5 to 50 ShA lower than that of the thermoplastic elastomer.

7. The compound according to claim 1, wherein the thermoplastic elastomer is a TPE-E and the additive is a TPE-U.

8. The compound according to claim 1, wherein the compound composition displays a volume change of less than 5 vol.-% under the action of silicone oil.

9. The compound according to claim 1, wherein the TPE compound can contain further TPEs, thermoplastic polymers and/or further additives.

10. The compound according to claim 1, wherein fillers, stabilizers and/or process additives can be present in the TPE compound as further additives.

11. The compound according to claim 1, wherein the further additives are selected from the group consisting of antistatic agents, anti-foam agents, lubricants, dispersants, release agents, antiblocking agents, radical scavengers, antioxidants, biocides, fungicides, UV stabilizers, other light-protection agents, metal deactivators, furthermore also additives such as foaming aids, propellants, flame-proofing agents, smoke suppressants, impact resistance modifying agents, adhesion promoters, anti-fog agents, dyes, pigments, colour masterbatches, viscosity modifiers, kaolin, mica, calcium sulfate, calcium carbonate, silicates, silica, talc, carbon black, graphite or synthetic fibres and combinations thereof.

12. The compound according to claim 1, wherein the further TPEs are contained in the range of 0-20 wt.-%, relative to the total weight of the TPE compound.

13. The compound according to claim 1, wherein the further thermoplastic polymers are contained in the range of 0-30 wt.-%, relative to the total weight of the TPE compound.

14. The compound according to claim 1, wherein the fillers are contained in the range of 0-25 wt.-%, UV stabilizers, process stabilizers and antioxidants in the range of from 0 to 0.5 wt.-%, relative to the total weight of the TPE compound.

15. An article of manufacture comprising the compound according to claim 1 as a component or a shaped body in the interior and external area of automobiles, of industrial devices, industrial tools, bathroom fittings and domestic appliances, medical consumables and devices, sporting goods, containers for hygiene products and cosmetics, sealing materials or preparations of consumables which contain silicone oils.
